(19) United States
(12) Patent Application Publication
(10) Pub. No.: US 2023/0262300 A1
(43) Pub. Date: Aug. 17, 2023

(54) INFORMATION PROCESSING APPARATUS AND CONTROL METHOD

(71) Applicant: Lenovo (Singapore) Pte. Ltd., Singapore (SG)

(72) Inventors: Koji Kawakita, Kanagawa (JP); Kazuo Fujii, Kanagawa (JP); David Douglas, Morrisville, NC (US); Kenneth Scott Seethaler, Morrisville, NC (US)

(73) Assignee: Lenovo (Singapore) Pte. Ltd, Singapore (SG)

(21) Appl. No.: 17/673,448

(22) Filed: Feb. 16, 2022

(51) Int. Cl. H04N 5/33; G06V 40/16; H04N 5/225; H04N 5/235; G06V 10/80

(52) U.S. Cl. CPC H04N 5/332; G06V 40/172; H04N 5/2258; H04N 5/2351; G06V 10/803

(57) ABSTRACT

An information processing apparatus includes: a first sensor that outputs a first output signal obtained by photoelectrically converting visible light incident through a color filter; a second sensor that outputs a second output signal obtained by photoelectrically converting visible light incident through a color filter or a third output signal obtained by photoelectrically converting light including infrared light incident without going through the color filter; a first processor that generates first image data based on the first output signal, and second image data based on the second output signal or the third output signal; a memory that temporarily stores the first image data and the second image data; a second processor that generates image data obtained by fusing the first image data and the second image data.

### FIELD OF THE INVENTION

The present invention relates to an information processing apparatus and a control method.

### BACKGROUND

There is disclosed a technique for recognizing a subject based on a visible light image obtained with a visible light camera and an infrared image (infrared light image) obtained with an infrared camera (for example, Japanese Unexamined Patent Application Publication No. 2009-201064). There is also disclosed a technique including two or more cameras to get visible light images. For example, there is disclosed a technique including dual cameras to combine visible light images respectively obtained by two image sensors in order to improve image quality (for example, Japanese Translation of PCT International Application Publication No. 2020-528700).

There are some information processing apparatuses, such as personal computers or smartphones, which are equipped with a face recognition function as one of ways to ensure security, but at the same time, there is also a demand for image quality improvement of visible light images in a shooting function. However, when an information processing apparatus is equipped with cameras to get two or more visible light images to improve image quality in the shooting function, since an infrared light image is suitable for performing face recognition with high accuracy, at least three or more cameras (image sensors) are required, and this has a large impact on the cost, the placement space for parts, and the like.

### SUMMARY

One or more embodiments of the present invention provide an information processing apparatus and a control method capable of getting an appropriate captured image with a simple configuration.

An information processing apparatus according to one or more embodiments of the present invention includes: a first sensor which outputs a first output signal obtained by photoelectrically converting visible light incident through a color filter; a second sensor which outputs a second output signal obtained by photoelectrically converting visible light incident through a color filter or a third output signal obtained by photoelectrically converting light including infrared light incident without going through the color filter; a first processor which generates first image data based on the first output signal output from the first sensor by shooting using the first sensor, and generates second image data based on the second output signal or the third output signal output from the second sensor by shooting using the second sensor; a memory which temporarily stores the first image data and the second image data generated by the first processor; a second processor which generates image data obtained by fusing the first image data and the second image data stored in the memory; and a third processor which executes processing using the image data generated by the second processor, wherein the second processor determines a scene captured using the first sensor and the second sensor, and controls which of the second output signal and the third output signal is output from the second sensor according to the determined scene.

The above information processing apparatus may also be such that, when determining a scene having a brightness of a predetermined threshold value or more by the scene determination, the second processor controls the second output signal to be output from the second sensor.

The above information processing apparatus may further be such that, when determining a low-light scene having a brightness of less than a predetermined threshold value or a backlit scene with a degree of backlight being a predetermined threshold value or more by the scene determination, the second processor controls the third output signal to be output from the second sensor.

The above information processing apparatus may further include a light-emitting part capable of emitting an infrared ray toward a shooting target upon shooting using the second sensor, wherein when determining the backlit scene by the scene determination, the second sensor controls the infrared ray to be emitted from the light-emitting part upon shooting using the second sensor.

The above information processing apparatus may also be such that, when determining the low-light scene by the scene determination, the second processor controls not to emit the infrared ray from the light-emitting part upon shooting using the second sensor.

Further, the above information processing apparatus may be such that the first processor performs face recognition processing for authenticating a face image captured in the image data generated by the second processor, and upon shooting using the second sensor to generate the image data used in the face recognition processing, the second processor controls the third output signal to be output from the second sensor.

Further, the above information processing apparatus may further include a light-emitting part capable of emitting an infrared ray toward a shooting target upon shooting using the second sensor, wherein upon shooting using the second sensor to generate the image data used in the face recognition processing, the second processor controls the infrared ray to be emitted from the light-emitting part.

Further, the above information processing apparatus may be such that the second processor can change the amount of light emission when emitting the infrared ray from the light-emitting part.

A control method according to one or more embodiments of the present invention is a control method for an information processing apparatus including: a first sensor which outputs a first output signal obtained by photoelectrically converting visible light incident through a color filter; a second sensor which outputs a second output signal obtained by photoelectrically converting visible light incident through a color filter or a third output signal obtained by photoelectrically converting light including infrared light incident without going through the color filter; a first processor which generates first image data based on the first output signal output from the first sensor by shooting using the first sensor, and generates second image data based on the second output signal or the third output signal output from the second sensor by shooting using the second sensor; a memory which temporarily stores the first image data and the second image data generated by the first processor; a second processor which generates image data obtained by fusing the first image data and the second image data stored in the memory; and a third processor which executes processing based on a system using the image data generated by the second processor, the control method including: a step of causing the second processor to determine a scene captured using the first sensor and the second sensor; and a step of causing the second processor to control which of the second output signal and the third output signal is output from the second sensor according to the determined scene.

The above-described aspects of the present invention can get an appropriate captured image with a simple configuration.

### BRIEF DESCRIPTION OF THE DRAWINGS

FIG. 1 is a perspective view illustrating the appearance of an information processing apparatus according to one or more embodiments.

FIG. 2 is a diagram illustrating an outline of shooting using a camera according to one or more embodiments.

FIG. 3 is a block diagram illustrating an example of the hardware configuration of the information processing apparatus according to one or more embodiments.

FIG. 4 is a block diagram illustrating an example of the functional configuration of a companion chip according to one or more embodiments.

FIG. 5 is a diagram illustrating an example of camera modes according to one or more embodiments.

FIG. 6 is a flowchart illustrating an example of camera mode switching processing according to one or more embodiments.

### DETAILED DESCRIPTION

Embodiments of the present invention will be described below with reference to the accompanying drawings.

[External Configuration]

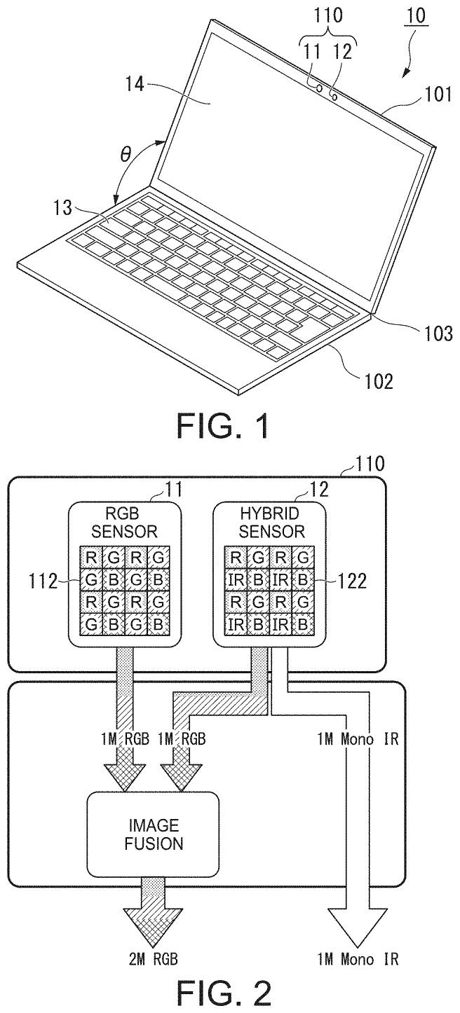

FIG. 1 is a perspective view illustrating the appearance of an information processing apparatus according to one or more embodiment. An information processing apparatus 10 illustrated is a clamshell laptop PC (Personal Computer). The information processing apparatus 10 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103 in such a manner that the first chassis 101 and the second chassis 102 are rotatable relative to each other around the rotation axis of the hinge mechanism 103.

A state where an open angle θ between the first chassis 101 and the second chassis 102 around the rotation axis is substantially 0° is a state where the first chassis 101 and the second chassis 102 are closed in such a manner as to overlap each other (called a “closed state”). Surfaces of the first chassis 101 and the second chassis 102 on the sides to face each other in the closed state are called “inner surfaces,” and surfaces on the other sides of the inner surfaces are called “outer surfaces,” respectively. The open angle θ can also be called an angle between the inner surface of the first chassis 101 and the inner surface of the second chassis 102. As opposed to the closed state, a state where the first chassis 101 and the second chassis 102 are open is called an “open state.” The open state is a state where the first chassis 101 and the second chassis 102 are rotated relative to each other until the open angle θ exceeds a preset threshold value (for example, 10°). Note that the open angle θ is often about 90° to 140° in general use.

A display unit 14 is provided on the inner surface of the first chassis 101. The display unit 14 displays pictures based on processing executed on the information processing apparatus 10. Further, a keyboard 13 is provided on the inner surface of the second chassis 102. The keyboard 13 is provided as an input device to accept user operations. In the closed state, the display unit 14 is not visible and any operation on the keyboard 13 is disabled. On the other hand, in the open state, the display unit 14 is visible and any operation on the keyboard 13 is enabled (that is, the information processing apparatus 10 is available).

Further, a camera 110 is provided in a peripheral area of the display unit 14 on the inner surface of the first chassis 101. The camera 110 is configured to include two cameras, that is, a first camera 11 and a second camera 12. For example, the first camera 11 and the second camera 12 are arranged side by side in a direction parallel to the inner surface of the first chassis 101. In other words, the camera 110 (first camera 11 and second camera 12) is provided in a position capable of capturing an image of a user using the information processing apparatus 10.

For example, when it is determined by face recognition whether or not to allow login to a system upon startup of the information processing apparatus 10, the camera 110 captures an image of the user who is on the face-to-face side. Note that the camera 110 is not limited to capturing the image of the user for face recognition at login, and may also capture the image of the user for face recognition to access data stored in the information processing apparatus 10. Further, the camera 110 is not limited to capturing the image of the user for face recognition, and also films a common video and capture a still image using a video call app, a video conferencing app, a camera app, and the like. In the following, an operating mode to capture an image for face recognition is called a “face recognition mode.” On the other hand, an operating mode to film a common video or capture a still image is called a “shooting mode.”

[Outline]

Referring next to FIG. 2, the first camera 11 and the second camera 12 included in the camera 110 will be described.

FIG. 2 is a diagram illustrating the outline of shooting using the camera 110 according to one or more embodiments. The first camera 11 and the second camera 12 are provided with different image sensors. The image sensors are, for example, CCD (Charge Coupled Device) or CMOS (Complementary Metal Oxide Semiconductor) sensors, or the like.

An image sensor provided in the first camera 11 is an RGB sensor 112 in which R pixels each having a color filter that transmits a wavelength band of R (Red), G pixels each having a color filter that transmits a wavelength band of G (Green), and B pixels each having a color filter that transmits a wavelength band of B (Blue) are arranged. For example, the RGB sensor 112 is an image sensor with a Bayer matrix in which an R pixel-G pixel row and a G pixel-B pixel row are alternately repeated. The RGB sensor 112 outputs an RGB image (visible light image) signal obtained by photoelectrically converting visible light incident through the RGB color filter.

An image sensor provided in the second camera 12 is a hybrid sensor 122 capable of outputting an IR (InfraRed) image signal obtained by photoelectrically converting infrared light in addition to the RGB signal. The hybrid sensor 122 has a matrix in which half of the G pixels in the Bayer matrix of the RGB sensor 112 are IR pixels on which infrared light can be incident, and the R pixel-G pixel row and an IR pixel-B pixel row are alternately repeated. The IR pixels receive light incident without going through the RGB color filter (i.e., light including infrared light).

The hybrid sensor 122 outputs an RGB image (visible light image) signal obtained by photoelectrically converting visible light incident on the R pixels, G pixels, and B pixels. Further, the hybrid sensor 122 outputs an IR image signal obtained by photoelectrically converting light incident on the IR pixels. Note that a filter that transmits only a wavelength band of infrared light is not provided on the IR pixels in one or more embodiments, and both the infrared light wavelength band and the visible-light wavelength band are incident on the IR pixels in the same way. Therefore, when infrared light is emitted toward a shooting target, the IR pixels mainly receive reflected light of the emitted infrared light reflected by the shooting target. Thus, the hybrid sensor 122 outputs an IR image signal. On the other hand, when infrared light is not emitted toward the shooting target, the IR pixels mainly receive visible light. Thus, the hybrid sensor 122 can also output a monochrome (Mono) image signal by visible light.

In other words, the hybrid sensor 122 can exclusively switch between the output of the RGB image signal obtained by photoelectrically converting visible light incident through the RGB color filter and the output of the IR image signal or the monochrome (Mono) image signal obtained by photoelectrically converting light incident without going through the RGB color filter.

For example, in the shooting mode, image quality can be improved by fusing an RGB image signal output from the RGB sensor 112 and an RGB image signal output from the hybrid sensor 122 to generate one image data (hereinafter called “fused image data”). As an example, a high-resolution RGB image with a pixel size of 2M can be obtained by fusing an RGB image signal with a pixel size of 1M output from the RGB sensor 112 and an RGB image signal with a pixel size of 1M output from the hybrid sensor 122. On the other hand, in the face recognition mode, face recognition can be performed with high accuracy by using the IR image signal output from the hybrid sensor 122.

Thus, the information processing apparatus 10 is equipped with the two image sensors of the RGB sensor 112 and the hybrid sensor 122 to be able to both improve the image quality of the RGB image in the shooting mode by switching the output of the hybrid sensor 122 and perform face recognition with high accuracy in the face recognition mode. Further, in the shooting mode, the information processing apparatus 10 not only gets a high-resolution RGB image by switching the output of the hybrid sensor 122 to the IR image signal or the monochrome (Mono) image signal depending on the shooting scene or the like, but also can improve image quality according to the shooting scene (for example, a low-light scene, a backlit scene, or the like). The configuration and functions of the information processing apparatus 10 will be described in detail below.

[Configuration of Information Processing Apparatus]

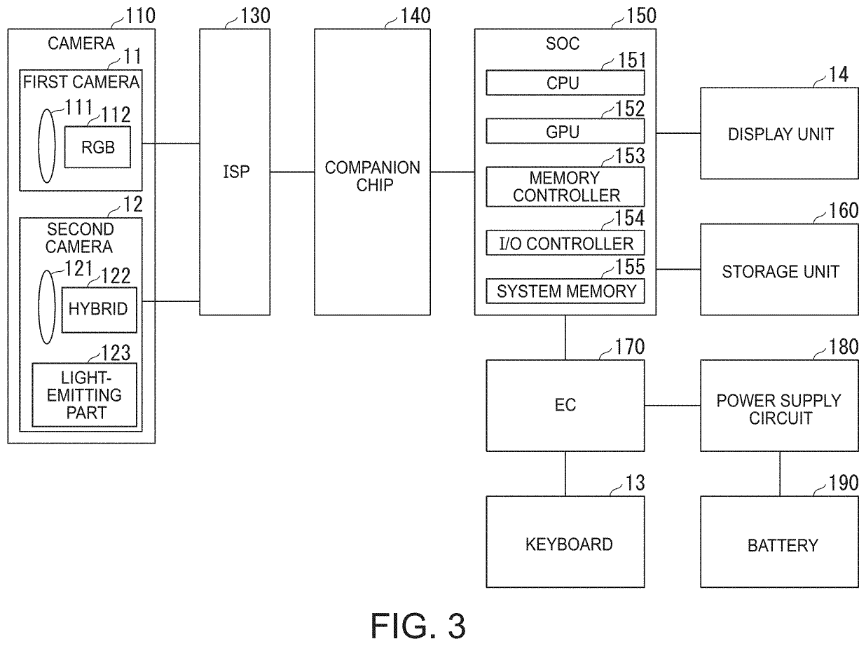

FIG. 3 is a block diagram illustrating an example of the hardware configuration of the information processing apparatus 10 according to one or more embodiments. In FIG. 3, each component corresponding to each part in FIG. 1 and FIG. 2 is given the same reference numeral. The information processing apparatus 10 includes the keyboard 13, the display unit 14, the camera 110, an ISP 130, a companion chip 140, a SOC 150, a storage unit 160, an EC 170, a power supply circuit 180, and a battery 190.

The keyboard 13 is an input device on which multiple keys (operators) to accept user operations are arranged. As illustrated in FIG. 1, the keyboard 13 is provided on the inner surface of the second chassis 102. The keyboard 13 outputs, to the EC 170, input information input with a user operation (for example, an operation signal indicative of an operated key(s)).

The display unit 14 is configured to include, for example, a liquid crystal display or an organic EL (Electro Luminescence) display to display display data based on processing executed by the SOC 150.

As described with reference to FIG. 1 and FIG. 2, the camera 110 includes the first camera 11 and the second camera 12. The first camera 11 has a lens 111 and the RGB sensor 112. Light from a shooting target is condensed by the lens 111 and incident on the RGB sensor 112. The RGB sensor 112 outputs an RGB image signal according to the incident light.

The second camera 12 has a lens 121, the hybrid sensor 122, and a light-emitting part 123. Light from the shooting target is condensed by the lens 121 and incident on the hybrid sensor 122. The hybrid sensor 122 outputs an RGB image signal, an IR image signal, or a monochrome (Mono) image signal according to the incident light. Switching among the RGB image signal, the IR image signal, and the monochrome (Mono) image signal is controlled by the companion chip 140 through the ISP 130. Further, the light-emitting part 123 is configured to include an LED (Light Emission Diode) capable of emitting an infrared ray toward the shooting target, and the like. The amount of light emission by the light-emitting part 123 is variable (adjustable), which is controlled by the companion chip 140 through the ISP 130.

The ISP 130 is an image processor (Image Signal Processor) for image processing to control shooting using the first camera 11 and the second camera 12. For example, the ISP 130 generates digital RGB image data based on an analog RGB image signal output from the RGB sensor 112 by shooting using the RGB sensor 112.

Further, the ISP 130 generates digital RGB image data based on an analog RGB image signal output from the hybrid sensor 122 by shooting using the hybrid sensor 122. Alternatively, the ISP 130 generates digital IR image data or monochrome (Mono) image data based on an analog IR image signal or a monochrome (Mono) image signal output from the hybrid sensor 122 by shooting using the hybrid sensor 122.

Further, in response to an instruction from the companion chip 140, the ISP 130 switches the output of the hybrid sensor 122 to the RGB image signal or the IR image signal (or the monochrome (Mono) image signal). As described above, both the IR image signal and the monochrome (Mono) image signal are output signals obtained by photoelectrically converting light received on the IR pixels, but are different depending on whether or not the infrared ray is emitted from the light-emitting part 123. When the output of the hybrid sensor 122 is the IR image signal, the ISP 130 controls the infrared ray to be emitted from the light-emitting part 123, while when the output of the hybrid sensor 122 is the monochrome (Mono) image signal, the ISP 130 controls the infrared ray not to be emitted from the light-emitting part 123. Similarly, when the output of the hybrid sensor 122 is the RGB image signal in response to the instruction from the companion chip 140, the ISP 130 controls the infrared ray not to be emitted from the light-emitting part 123.

Then, the ISP 130 temporarily stores the generated RGB image data, IR image data, or monochrome (Mono) image data in a memory (for example, a system memory 155). The memory to store the image data may also a memory separately connected to the ISP 130 instead of the system memory 155 provided in the SOC 150.

Further, the ISP 130 outputs shooting conditions, such as exposure time, gain, ISO sensitivity, and AE (Automatic Exposure) target position, when shooting using the first camera 11 and the second camera 12, and image information such as the histogram and illuminance of a captured image.

Further, the ISP 130 detects an area of a face image (face area) from the RGB image data, the IR image data, or the monochrome (Mono) image data. For example, the ISP 130 detects whether or not a person is included in the captured image (whether or not the user using the information processing apparatus 10 is present in the shooting target direction), and detects the position (face position) when the person is included. Further, the ISP 130 executes face recognition processing by checking the detected face image against a preregistered face image (a face image of an authorized user). The ISP 130 outputs the detected face area, the presence or absence of a person, the face recognition result, and the like.

The companion chip 140 generates fused image data obtained by fusing RGB image data, generated by the ISP 130 based on the RGB image signal output form the first camera 11 (RGB sensor 112), and RGB image data, IR image data, or monochrome (Mono) image data generated by the ISP 130 based on the RGB image signal, IR image signal, or monochrome (Mono) image signal output from the second camera 12 (hybrid sensor 122). Further, the companion chip 140 determines a scene captured using the first camera 11 (RGB sensor 112) and the second camera 12 (hybrid sensor 122), and controls which of the RGB image signal and the IR image signal (or the monochrome (Mono) image signal) is output from the second camera 12 (hybrid sensor 122) according to the determined scene. The configuration and processing related to the control of a captured image by this companion chip 140 will be described in detail later.

The SOC (system-on-a-chip) 150 is configured to include, in the same package, a CPU (Central Processing Unit) 151, a GPU (Graphic Processing Unit) 152, a memory controller 153, an I/O (Input-Output) controller 154, the system memory 155, and the like. Note that some of components included in the SOC 150 may also be connected to the SOC 150 as separate parts. Further, respective components included in the SOC 150 may be configured as separate parts without being limited to the components of the SOC.

The CPU 151 executes processing by a system such as a BIOS or an OS and processing by an application program running on the OS. For example, the CPU 151 executes face recognition processing using image data generated by the companion chip 140, display/editing processing of a captured image, and the like.

The GPU 152 generates display data under the control of the CPU 151, and outputs the display data to the display unit 14.

The memory controller 153 controls reading and writing of data from and to the system memory 155 or the storage unit 160 under the control of the CPU 151 and the GPU 152.

The I/O controller 154 controls input and output of data to and from the display unit 14 and the EC 170.

The system memory 155 is used as reading areas of execution programs of a processor and working areas to which processing data are written. Further, the system memory 155 temporarily stores the RGB image data, the IR image data, and the monochrome (Mono) image data generated by the ISP 130, and fused image data generated by the companion chip 140, and the like.

The storage unit 160 is configured to include storage media such as an HDD (Hard Disk Drive) or an SSD (Solid State Drive), a secure NVRAM (Non-Volatile RAM), and a ROM (Read Only Memory). The HDD or the SSD stores various programs such as the OS, device drivers, and applications, and various data. The secure NVRAM stores authentication data used, for example, to authenticate the user.

The EC 170 is a one-chip microcomputer which monitors and controls various devices (peripheral devices, sensors, and the like). The EC 170 includes a CPU, a ROM, a RAM, multi-channel A/D input terminal and D/A output terminal, a timer, and digital input/output terminals, which are not illustrated. To the digital input/output terminals of the EC 170, for example, the keyboard 13, the power supply circuit 180, and the like are connected. The EC 170 receives input information (operation signal) from the keyboard 13. Further, the EC 170 controls the operation of the power supply circuit 180 and the like.

The power supply circuit 180 is configured to include, for example, a DC/DC converter, a charge/discharge unit, and the like. For example, the power supply circuit 180 converts DC voltage supplied from an external power supply such as an AC adapter (not illustrated) or the battery 190 into plural voltages required to operate the information processing apparatus 10, and supplies power to each unit of the information processing apparatus 10 under the control of the EC 170.

The battery 190 is, for example, a lithium battery, which is charged through the power supply circuit 180 when power is supplied from the external power supply, and discharges the power charged through the power supply circuit 180 as power to operate each unit of the information processing apparatus 10 when no power is supplied from the external power supply.

[Functional Configuration]

Next, a functional configuration related to captured image control by the companion chip 140 will be described.

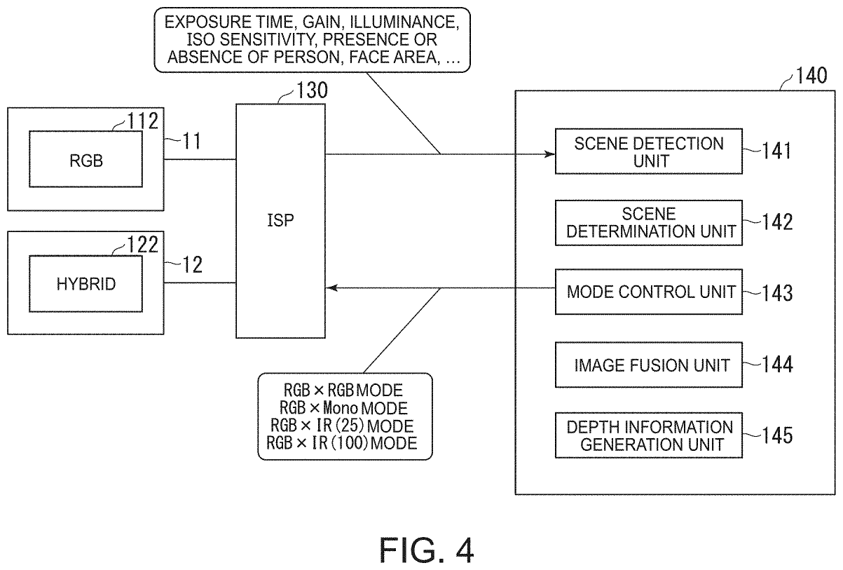

FIG. 4 is a block diagram illustrating an example of the functional configuration of the companion chip 140 according to one or more embodiments. The companion chip 140 includes, as the functional configuration related to captured image control, a scene detection unit 141, a scene determination unit 142, a mode control unit 143, an image fusion unit 144, and a depth information generation unit 145.

The scene detection unit 141 acquires, from the ISP 130, information indicative of the shooting conditions upon shooting using the first camera 11 and the second camera 12, image information on a captured image, and context information, such as a face area detected from the captured image, the presence or absence of a person, and the like, to detect a shooting scene based on the acquired information. For example, the shooting conditions include exposure time, gain, ISO sensitivity, AE target position, and the like. The image information on the captured image includes, for example, information on histogram, illuminance, and the like. For example, the scene detection unit 141 detects the overall brightness (illuminance) of the shooting scene, the presence or absence of a person, the position of the person in the captured image when the person is present, the illuminance difference between the person and the background, and the like.

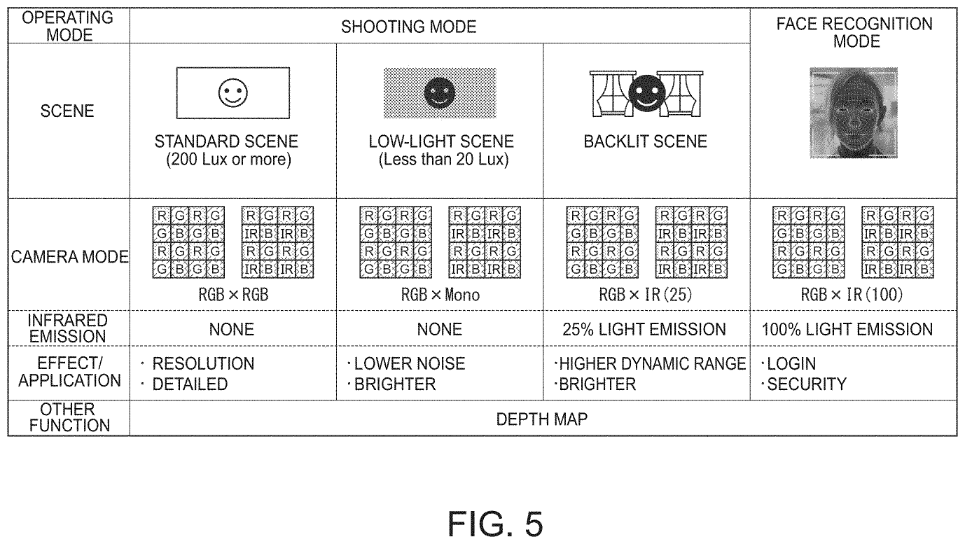

The scene determination unit 142 determines a scene based on the shooting scene detected by the scene detection unit 141. For example, the scene determination unit 142 classifies the shooting scene detected by the scene detection unit 141 into either of preset multiple types of scenes. The mode control unit 143 controls switching among camera modes in each of which a combination of outputs of the first camera 11 (RGB sensor 112) and the second camera 12 (hybrid sensor 122) is defined according to the scene determined by the scene determination unit 142. In other words, the mode control unit 143 controls the output of the hybrid sensor 122 and the light emission of the light-emitting part 123 according to the scene determined by the scene determination unit 142. Then, the image fusion unit 144 generates fused image data obtained by fusing image data based on the output of the RGB sensor 112 and image data based on the output of the hybrid sensor 122. A concrete example will be described with reference to FIG. 5.

FIG. 5 is a diagram illustrating an example of camera modes according to one or more embodiments. For example, in the shooting mode, shooting scenes are classified into a standard scene, a low-light scene, and a backlit scene. As an example, the standard scene is defined as a scene with an illuminance of 200 Lux or more. As an example, the low-light scene is defined as a scene with an illuminance of less than 20 Lux. The backlit scene is a scene in which a person is present, which is defined as a backlit scene with a degree of backlight due to the illuminance difference between the person (face area) and the background being a predetermined threshold value or more.

Further, a camera mode in which a combination of outputs of the camera 110 is defined for each scene is set. A camera mode for the standard scene is set to “RGB×RGB” mode. The “RGB×RGB” mode is a mode in which the output of the RGB sensor 112 is the RGB image signal, the output of the hybrid sensor 122 is the RGB image signal, and no infrared ray is emitted from the light-emitting part 123.

A camera mode for the low-light scene is set to “RGB×Mono” mode. The “RGB×Mono” mode is a mode in which the output of the RGB sensor 112 is the RGB image signal, the output of the hybrid sensor 122 is the monochrome (Mono) image signal, and no infrared ray is emitted from the light-emitting part 123.

A camera mode for the backlit scene is set to “RGB×IR(25)” mode. The “RGB×IR(25)” mode is a mode in which the output of the RGB sensor 112 is the RGB image signal, the output of the hybrid sensor 122 is the IR image signal, and the light-emitting part 123 is caused to emit light with an emission level of 25%. In the following, an IR image obtained when the light-emitting part 123 is caused to emit light with the emission level of 25% is called “IR(25) image.”

Thus, in the shooting mode, each camera mode is defined by the shooting scene. On the other hand, in the face recognition mode, the camera mode is set to “RGB×IR(100)” mode. The “RGB×IR(100)” mode is a mode in which the output of the RGB sensor 112 is the RGB image signal, the output of the hybrid sensor 122 is the IR image signal, and the light-emitting part 123 is caused to emit light with an emission level of 100%. In the following, an IR image obtained when the light-emitting part 123 is caused to emit light with the emission level of 100% is called “IR(100) image.”

In the shooting mode, when the standard scene is determined by the scene determination unit 142, the mode control unit 143 controls the camera mode to the “RGB×RGB” mode. In other words, the mode control unit 143 controls the RGB image signal to be output from the hybrid sensor 122. For example, the mode control unit 143 gives an instruction of the “RGB×RGB” mode to the ISP 130. By this instruction, the ISP 130 controls the hybrid sensor 122 to output the RGB image signal. At this time, the ISP 130 controls the light-emitting part 123 not to emit light.

Thus, the ISP 130 generates RGB image data based on the RGB image signal output from the RGB sensor 112, and temporarily stores the RGB image data in the system memory 155. Further, the ISP 130 generates RGB image data based on the RGB image signal output from the hybrid sensor 122, and temporarily stores the RGB image data in the system memory 155.

Then, the image fusion unit 144 reads, from the system memory 155, the RGB image data based on the RGB image signal output from the RGB sensor 112, and the RGB image data based on the RGB image signal output from the hybrid sensor 122 to generate fused image data obtained by fusing both image data. Thus, a high-quality RGB image higher in resolution and more detailed than the images before being fused can be obtained.

Further, in the shooting mode, when the low-light scene is determined by the scene determination unit 142, the mode control unit 143 controls the camera mode to the “RGB×Mono” mode. In other words, the mode control unit 143 controls the monochrome (Mono) image signal to be output from the hybrid sensor 122. For example, the mode control unit 143 gives an instruction of the “RGB×Mono” mode to the ISP 130. By this instruction, the ISP 130 controls the hybrid sensor 122 to output the monochrome (Mono) image signal. At this time, the ISP 130 controls the light-emitting part 123 not to emit light.

Thus, the ISP 130 generates RGB image data based on the RGB image signal output from the RGB sensor 112, and temporarily stores the RGB image data in the system memory 155. Further, the ISP 130 generates monochrome (Mono) image data based on the monochrome (Mono) image signal output from the hybrid sensor 122, and temporarily stores the monochrome (Mono) image data in the system memory 155.

Then, the image fusion unit 144 reads, from the system memory 155, the RGB image data based on the RGB image signal output from the RGB sensor 112, and the monochrome (Mono) image data based on the monochrome (Mono) image signal output from the hybrid sensor 122 to generate fused image data obtained by fusing both image data. Thus, a high-quality RGB image lower in noise and brighter than the images before being fused can be obtained.

Further, in the shooting mode, when the backlit scene is determined by the scene determination unit 142, the mode control unit 143 controls the camera mode to the “RGB×IR(25)” mode. In other words, the mode control unit 143 controls the IR(25) image signal to be output from the hybrid sensor 122. For example, the mode control unit 143 gives an instruction of the “RGB×IR(25)” mode to the ISP 130. By this instruction, the ISP 130 controls the hybrid sensor 122 to output the IR(25) image signal. Specifically, the ISP 130 controls the hybrid sensor 122 to output the IR image signal, and controls the light-emitting part 123 to emit light with the emission level of 25%.

Thus, the ISP 130 generates RGB image data based on the RGB image signal output from the RGB sensor 112, and temporarily stores the RGB image data in the system memory 155. Further, the ISP 130 generates IR(25) image data based on the IR(25) image signal output from the hybrid sensor 122, and temporarily stores the IR(25) image data in the system memory 155.

Then, the image fusion unit 144 reads, from the system memory 155, the RGB image data based on the RGB image signal output from the RGB sensor 112, and the IR(25) image data based on the IR(25) image signal output from the hybrid sensor 122 to generate fused image data obtained by fusing both image data. Thus, a high-quality RGB image higher in dynamic range and brighter than the images before being fused can be obtained.

Further, in the state of being controlled to each camera mode in the shooting mode, the scene determination unit 142 determines a shooting scene based on image data read from the system memory 155. Then, the mode control unit 143 controls the camera mode according to the scene determined by the scene determination unit 142. In other words, the determination of a shooting scene is repeatedly made to update the camera mode.

On the other hand, in the face recognition mode, the mode control unit 143 controls the camera mode to the “RGB×IR(100)” mode. In other words, the mode control unit 143 controls the IR(100) image signal to be output from the hybrid sensor 122. For example, the mode control unit 143 gives an instruction of the “RGB×IR(100)” mode to the ISP 130. By this instruction, the ISP 130 controls the hybrid sensor 122 to output the IR(100) image signal. Specifically, the ISP 130 controls the hybrid sensor 122 to output the IR image signal, and controls the light-emitting part 123 to emit light with the emission level of 100%.

Thus, the ISP 130 generates RGB image data based on the RGB image signal output from the RGB sensor 112, and temporarily stores the RGB image data in the system memory 155. Further, the ISP 130 generates IR(100) image data based on the IR(100) image signal output from the hybrid sensor 122, and temporarily stores the IR(100) image data in the system memory 155.

Then, the image fusion unit 144 reads, from the system memory 155, the RGB image data based on the RGB image signal output from the RGB sensor 112, and the IR(100) image data based on the IR(100) image signal output from the hybrid sensor 122 to generate fused image data obtained by fusing both image data. The information processing apparatus 10 uses this fused image data to perform face recognition processing at login and face recognition processing as a way to ensure security when accessing data stored in the storage unit 160. Since the information processing apparatus 10 perform the face recognition processing by adding the IR image to the RGB image, face recognition can be done with high accuracy.

Returning to FIG. 4, the depth information generation unit 145 generates a depth map using a parallax between image data captured with the first camera 11 and image data captured with the second camera 12 (other function in FIG. 5). Since both the first camera 11 and the second camera 12 are used for shooting in either camera mode, the depth information generation unit 145 can generate the depth map.

[Camera Mode Switching Processing]

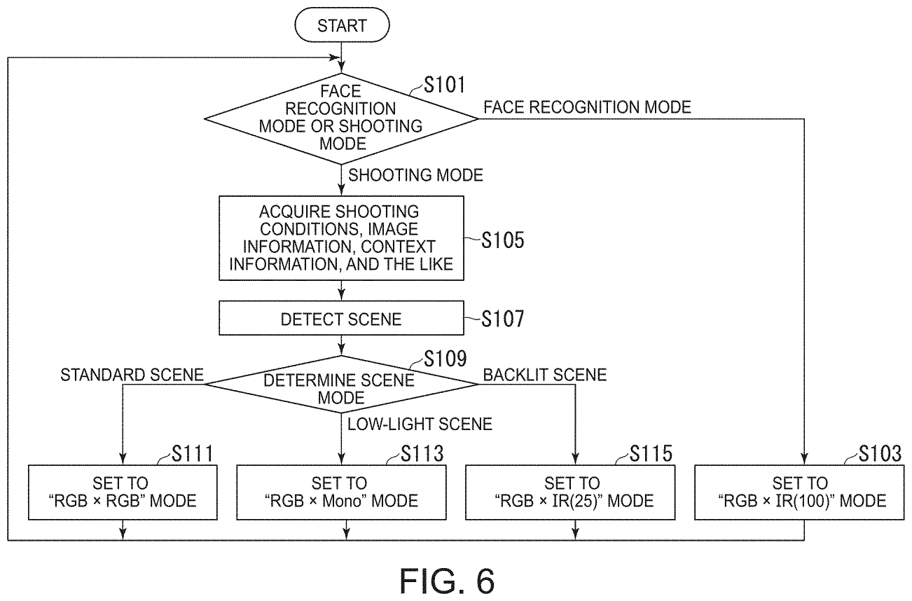

Referring next to FIG. 6, the operation of camera mode switching processing performed by the companion chip 140 to switch among the camera modes will be described.

FIG. 6 is a flowchart illustrating an example of camera mode switching processing according to one or more embodiments.

(Step S101) When receiving a shooting trigger, the companion chip 140 determines whether it is shooting in the face recognition mode or shooting in the shooting mode. When determining that it is shooting in the face recognition mode, the companion chip 140 proceeds to a process in step S103. On the other hand, when determining that it is shooting in the shooting mode, the companion chip 140 proceeds to a process in step S105.

(Step S103) The companion chip 140 controls the camera mode to the “RGB×IR(100)” mode in the face recognition mode. Then, the companion chip 140 returns to the process in step S101.

(Step S105) The companion chip 140 acquires, from the ISP 130, information indicative of shooting conditions upon shooting using the first camera 11 and the second camera 12, image information on a captured image, and context information such as a face area detected from the captured image, the presence or absence of a person, and the like. Then, the companion chip 140 proceeds to a process in step S107.

(Step S107) The companion chip 140 detects a shooting scene based on the information acquired in step S105, and proceeds to a process in step S109.

(Step S109) The companion chip 140 determines a scene based on the shooting scene detected in step S109. For example, when determining that the shooting scene is the standard scene, the companion chip 140 proceeds to a process in step S111. When determining that the shooting scene is the low-light scene, the companion chip 140 proceeds to a process in step S113. Further, when determining that the shooting scene is the backlit scene, the companion chip 140 proceeds to a process in step S115.

(Step S111) The companion chip 140 controls the camera mode to the “RGB×RGB” mode in the standard scene. Then, the companion chip 140 returns to the process in step S101.

(Step S113) The companion chip 140 controls the camera mode to the “RGB×Mono” mode in the low-light scene. Then, the companion chip 140 returns to the process in step S101.

(Step S115) The companion chip 140 controls the camera mode to the “RGB×IR(25)” mode in the backlit scene. Then, the companion chip 140 returns to the process in step S101.

[Summary]

As described above, the information processing apparatus 10 according to one or more embodiments includes the RGB sensor 112 (an example of a first sensor), the hybrid sensor 122 (an example of a second sensor), the ISP 130 (an example of a first processor), the companion chip 140 (an example of a second processor), the CPU 151 (an example of a third processor), and the system memory 155 (an example of a memory). The RGB sensor 112 outputs an RGB image signal (an example of a first output signal) obtained by photoelectrically converting visible light incident through a color filter. The hybrid sensor 122 outputs an RGB image signal (an example of a second output signal) obtained by photoelectrically converting visible light incident through a color filter or an IR image signal (an example of a third output signal) obtained by photoelectrically converting light including infrared light incident without going through the color filter. The ISP 130 generates RGB image data (an example of first image data) based on the RGB image signal output from the RGB sensor 112 by shooting using the RGB sensor 112. Further, the ISP 130 generates RGB image data (an example of second image data) or IR image data (another example of second image data) based on the RGB image signal or the IR image signal output from the hybrid sensor 122 by shooting using the hybrid sensor 122. The system memory 155 temporarily stores image data generated by the ISP 130. For example, the system memory 155 temporarily stores the RGB image data based on the RGB image signal output from the RGB sensor 112, and the RGB image data or the IR image data based on the RGB image signal or the IR image signal output from the hybrid sensor 122. The companion chip 140 generates fused image data obtained by fusing the RGB image data based on the RGB image signal output from the RGB sensor 112 and the RGB image data or the IR image data based on the RGB image signal or the IR image signal output from the hybrid sensor 122, where both image data are stored in the system memory 155. The CPU 151 executes processing using the fused image data generated by the companion chip 140. Further, the companion chip 140 determines a scene captured using the RGB sensor 112 and the hybrid sensor 122 to control which of the RGB image signal and the IR image signal is output from the hybrid sensor 122 according to the determined scene.

Thus, the information processing apparatus 10 is equipped with two image sensors, that is, the RGB sensor 112 and the hybrid sensor 122, and can get a high-quality captured image by switching among outputs of the hybrid sensor 122 according to the shooting scene. Therefore, the information processing apparatus 10 can get an appropriate captured image with a simple configuration.

For example, when the standard scene having the brightness of the predetermined threshold value (for example, 200 Lux) or more is determined by the determination of a shooting scene, the companion chip 140 controls the RGB image signal to be output from the hybrid sensor 122.

Thus, since fused image data obtained by fusing the RGB image data by the RGB sensor 112 and the RGB image data by the hybrid sensor 122 is generated in the standard scene, the information processing apparatus 10 can get a high-quality RGB image higher in resolution and more detailed than the images before being fused.

Further, when the low-light scene having the brightness of less than the predetermined threshold value (for example, 20 Lux) is determined by the determination of a shooting scene, the companion chip 140 controls the monochrome (Mono) image signal (an example of the third output signal) to be output from the hybrid sensor 122. Further, when the backlit scene with the degree of backlight being the predetermined threshold value or more is determined by the determination of a shooting scene, the companion chip 140 controls the IR image signal (another example of the third output signal) to be output from the hybrid sensor 122.

Thus, since fused image data obtained by fusing the RGB image data by the RGB sensor 112 and the monochrome (Mono) image data by the hybrid sensor 122 is generated in the low-light scene, the information processing apparatus 10 can get a high-quality RGB image lower in noise and brighter than the images before being fused. Further, since fused image data obtained by fusing the RGB image data by the RGB sensor 112 and the IR image data by the hybrid sensor 122 is generated in the backlit scene, the information processing apparatus 10 can get a high-quality RGB image higher in dynamic range and brighter than the images before being fused.

Note that the information processing apparatus 10 further includes the light-emitting part 123 capable of emitting an infrared ray toward a shooting target upon shooting using the hybrid sensor 122. When the backlit scene is determined by the determination of a shooting scene, the companion chip 140 controls the infrared ray to be emitted from the light-emitting part 123 upon shooting using the hybrid sensor 122.

Thus, since IR(25) image data based on the IR(25) image signal output from the hybrid sensor 122 is acquired in the backlit scene and fused with the RGB image data by the RGB sensor 112, the information processing apparatus 10 can perform backlight compensation using a captured image by the infrared light to get a high-quality RGB image with higher dynamic range and brightness.

Further, when the low-light scene is determined by the determination of a shooting scene, the companion chip 140 controls the infrared ray not to be emitted from the light-emitting part 123 upon shooting using the hybrid sensor 122.

Thus, since monochrome (Mono) image data based on the monochrome (Mono) image signal output from the hybrid sensor 122 is acquired in the low-light scene and fused with the RGB image data by the RGB sensor 112, the information processing apparatus 10 can get a high-quality RGB image with lower noise and higher brightness.

Further, the CPU 151 performs face recognition processing for authenticating a face image captured in fused image data generated by the companion chip 140. When shooting using the hybrid sensor 122 to generate the fused image data used in the face recognition processing mentioned above, the companion chip 140 controls the IR image signal to be output from the hybrid sensor 122.

Thus, since the information processing apparatus 10 performs the face recognition processing by adding the IR image to the RGB image, face recognition can be done with high accuracy.

Note that when shooting using the hybrid sensor 122 to generate the fused image data used in the face recognition processing mentioned above, the companion chip 140 controls an infrared ray to be emitted from the light-emitting part 123.

Thus, the information processing apparatus 10 can perform face recognition with high accuracy even in a low-light environment.

Further, the companion chip 140 can change the amount of light emission when emitting the infrared ray from the light-emitting part 123. For example, the companion chip 140 can change the amount of light emission when emitting the infrared ray from the light-emitting part 123 according to the shooting scene or according to the function (shooting mode or face recognition mode).

Thus, the information processing apparatus 10 can get an appropriate ID image according to the shooting scene or the function.

Further, a control method for an information processing apparatus including the RGB sensor 112 (the example of the first sensor), the hybrid sensor 122 (the example of the second sensor), the ISP 130 (the example of the first processor), the companion chip 140 (the example of the second processor), the CPU 151 (the example of the third processor), and the system memory 155 (the example of the memory) includes: a step of causing the companion chip 140 to determine a scene captured using the RGB sensor 112 and the hybrid sensor 122; and a step of causing the companion chip 140 to control which of the RGB image signal and the IR image signal is output from the hybrid sensor 122 according to the determined scene.

Thus, the information processing apparatus 10 is equipped with two image sensors, that is, the RGB sensor 112 and the hybrid sensor 122, and can get a high-quality captured image by switching among outputs of the hybrid sensor 122 according to the shooting scene. Therefore, the information processing apparatus 10 can get an appropriate captured image with a simple configuration.

While embodiments of this invention have been described in detail above with reference to the accompanying drawings, those skilled in the art, having benefit of this disclosure, will appreciate that the specific configuration is not limited to that in the above-described embodiments. Various other embodiments may be devised without departing from the scope of the present invention. For example, respective components described in the above-described embodiments can be combined arbitrarily. Accordingly, the scope of the invention should be limited only by the attached claims.

Further, the description is made in the aforementioned embodiments by taking the standard scene, the low-light scene, and the backlit scene as categories of shooting scenes, but any other category may also be provided. Further, the amount of light emission of the light-emitting part 123 is set to 25% in the backlit scene, but the present invention is not limited thereto, and any other amount of light emission can be set. Similarly, the amount of light emission of the light-emitting part 123 is set to 100% in the face recognition mode, but the present invention is not limited thereto, and any other amount of light emission can be set.

Further, the ISP 130 and the companion chip 140 described in the aforementioned embodiments may be configured as one integrated processor. Further, the ISP 130, the companion chip 140, and the SOC 150 may be configured as one integrated processor.

Note that the information processing apparatus 10 described above has a computer system therein. Then, a program for implementing the function of each component included in the information processing apparatus 10 described above may be recorded on a computer-readable recording medium so that the program recorded on this recording medium is read into the computer system and executed to perform processing in each component included in the information processing apparatus 10 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may include two or more computer devices connected through a network including the Internet, WAN, LAN, and a communication line such as a dedicated line. Further, the “computer-readable recording medium” means a storage medium such as a flexible disk, a magneto-optical disk, a ROM, a portable medium like a CD-ROM, or a hard disk incorporated in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 10, or delivery servers for delivering respective divided pieces of the program may be different from one another. Further, the “computer-readable recording medium” includes a medium on which the program is held for a given length of time, such as a volatile memory (RAM) inside a computer system as a server or a client when the program is transmitted through the network. The above-mentioned program may also be to implement some of the functions described above. Further, the program may be a so-called differential file (differential program) capable of implementing the above-described functions in combination with a program(s) already recorded in the computer system.

Further, some or all of the above-described functions of the information processing apparatus 10 in the above-described embodiments may be realized as an integrated circuit such as LSI (Large Scale Integration). Each of the functions may be implemented as a processor individually, or part or the whole thereof may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

10 information processing apparatus
13 keyboard
14 display unit
110 camera
130 ISP
140 companion chip
141 scene detection unit
142 scene determination unit
143 mode control unit
144 image fusion unit
145 depth information generation unit
150 SOC
151 CPU
152 GPU
153 memory controller
154 I/O controller
155 system memory
160 storage unit
170 EC
180 power supply circuit
190 battery

1. An information processing apparatus comprising:
a first sensor that outputs a first output signal obtained by photoelectrically converting visible light incident through a color filter;
a second sensor that outputs:
a second output signal obtained by photoelectrically converting visible light incident through a color filter, or
a third output signal obtained by photoelectrically converting light including infrared light incident without going through the color filter;
a first processor that generates:
first image data based on the first output signal output from the first sensor by shooting using the first sensor, and
second image data based on the second output signal or the third output signal output from the second sensor by shooting using the second sensor;
a memory that temporarily stores the first image data and the second image data generated by the first processor;
a second processor that generates image data obtained by fusing the first image data and the second image data stored in the memory; and
a third processor that executes processing using the image data generated by the second processor,
wherein the second processor is configured to:
acquire, from the first processor, shooting condition information, image information, or context information to determine a scene captured using the first sensor and the second sensor, and
transmit, to the first processor, an instruction to control which of the second output signal and the third output signal is output from the second sensor according to the determined scene, and
wherein the first processor is configured to, after receiving the instruction from the second processor, switch the output of the second sensor based on the instruction.

2. The information processing apparatus according to claim 1, wherein when the determined scene has a brightness greater than or equal to a predetermined threshold value, the second processor controls the second output signal to be output from the second sensor.

3. The information processing apparatus according to claim 1, wherein when the determined scene is a low-light scene having a brightness less than a predetermined threshold value or a backlit scene with a degree of backlight greater than or equal to a predetermined threshold value, the second processor controls the third output signal to be output from the second sensor.

4. The information processing apparatus according to claim 3, further comprising
a light-emitting part capable of emitting an infrared ray toward a shooting target upon shooting using the second sensor,
wherein when the determined scene is the backlit scene, the second processor controls the infrared ray to be emitted from the light-emitting part upon shooting using the second sensor.

5. The information processing apparatus according to claim 4, wherein when the determined scene is the low-light scene, the second processor controls not to emit the infrared ray from the light-emitting part upon shooting using the second sensor.

6. The information processing apparatus according to claim 1, wherein
the first processor performs face recognition processing for authenticating a face image captured in the image data generated by the second processor, and
upon shooting using the second sensor to generate the image data used in the face recognition processing, the second processor controls the third output signal to be output from the second sensor.

7. The information processing apparatus according to claim 6, further comprising
a light-emitting part capable of emitting an infrared ray toward a shooting target upon shooting using the second sensor,
wherein upon shooting using the second sensor to generate the image data used in the face recognition processing, the second processor controls the infrared ray to be emitted from the light-emitting part.

8. The information processing apparatus according to claim 4, wherein an amount of light emission from the light-emitting part is configured by the second processor.

9. The information processing apparatus according to claim 7, wherein an amount of light emission from the light-emitting part is configured by the second processor.

10. A control method for an information processing apparatus including: a first sensor which outputs a first output signal obtained by photoelectrically converting visible light incident through a color filter; a second sensor which outputs a second output signal obtained by photoelectrically converting visible light incident through a color filter or a third output signal obtained by photoelectrically converting light including infrared light incident without going through the color filter; a first processor which generates first image data based on the first output signal output from the first sensor by shooting using the first sensor, and generates second image data based on the second output signal or the third output signal output from the second sensor by shooting using the second sensor; a memory which temporarily stores the first image data and the second image data generated by the first processor; a second processor which generates image data obtained by fusing the first image data and the second image data stored in the memory; and a third processor which executes processing based on a system using the image data generated by the second processor, the control method comprising:
acquiring, by the second processor, shooting condition information, image information, or context information from the first processor;
determining, by the second processor, a scene captured using the first sensor and the second sensor based on the shooting condition information, the image information, or the context information from the first processor;
transmitting, by the second processor, an instruction to the first processor to control which of the second output signal and the third output signal is output from the second sensor according to the determined scene; and
switching, by the first processor, which of the second output signal and the third output signal is output from the second sensor based on the instruction.

11. The information processing apparatus according to claim 1, wherein first processor and the second processor are configured as blocks of one integrated processor.

12. The information processing apparatus according to claim 1, wherein first processor, the second processor, and the third processor are configured as blocks of one integrated processor.

13. The information processing apparatus according to claim 1, wherein first processor, the second processor, and the third processor are configured as separate processors.
